(19) United States
(12) Patent Application Publication
(10) Pub. No.: US 2025/0100915 A1
(43) Pub. Date: Mar. 27, 2025

(54) PROCESS FOR CONTROLLING CYANOBACTERIA

(71) Applicant: BioSafe Systems LLC, East Hartford, CT (US)

(72) Inventor: Thomas Michael Warmuth, Kure Beach, NC (US)

(21) Appl. No.: 18/899,106

(22) Filed: Sep. 27, 2024

Related U.S. Application Data
(60) Provisional application No. 63/585,621, filed on Sep. 27, 2023.

(51) Int. Cl. C02F 1/50; C02F 103/00

(52) U.S. Cl. CPC C02F 1/50; C02F 2103/007; C02F 2303/04; C02F 2305/14

(57) ABSTRACT

Cyanobacteria growth in a thermally stratified body of water for treatment is controlled by dispersing a granular sodium carbonate peroxyhydrate in the benthic layer early in the growing season.

### CROSS-REFERENCE TO RELATED APPLICATION

This application claims the benefit of U.S. Provisional Patent Application 63/585,621, filed Sep. 27, 2023, which is incorporated herein by reference.

### BACKGROUND OF THE INVENTION

### 1. Field of the Invention

The present invention relates to processes for treating the growth of undesired aquatic organisms.

### 2. Brief Description of the Prior Art

Many cyanobacteria (also known as “blue-green algae”) live and proliferate in waterbodies across the world and their annual growth often begins at the bottom of a lake, pond, reservoir, or other surface water. The life cycle for many problematic cyanobacteria begins early when the colder season water begins to warm in the benthic region of the water column, reaching about 15° C./60° F., much earlier in the season than when they start causing problems when water temperatures become much warmer and these cyanobacteria “bloom” throughout the water column and surface of the waterbody.

### SUMMARY OF THE INVENTION

The process of the present invention provides a method for controlling cyanobacteria in a body of water. The process comprises selecting a thermally stratified body of water, or a body of water otherwise containing over-wintering cyanobacteria located within the benthos, or bottom, of the water body for treatment. The benthic layer may be colder than overlying layers wherein the benthic layer including cyanobacteria. Preferably, the cyanobacteria are in their early stages of growth. Preferably, cyanobacteria are identified beneath the surface of the benthic or lowest layer of a water body. Preferably, the process further includes providing a granular source of hydrogen peroxide. Preferably, the granular source has a density greater than the density of the water, such that the granular source sinks in the water body. Preferably, the process further includes dispersing the granular source in the body of water. Preferably, the process further includes permitting the granular source to disperse from the surface of the body to the benthic layer. Preferably, the process further includes the granular source providing hydrogen peroxide to the benthic layer. In one presently preferred embodiment, the process further includes dispersing the granular source on the surface of the body of water. Preferably, the granular source of hydrogen peroxide is sodium carbonate peroxyhydrate. Preferably, the granular source of hydrogen peroxide has an average particle size of about 700 microns to 900 microns. Preferably, the granular source of hydrogen peroxide dissolves in the benthic layer. Preferably, body of water has a bottom, and the granular source of hydrogen peroxide is provided adjacent the bottom of the body of water. Preferably, the granular source of hydrogen peroxide releases hydrogen peroxide adjacent the bottom of the body of water. Preferably, the quantity of hydrogen peroxide released is sufficient to control the cyanobacteria.

### DETAILED DESCRIPTION

This invention preferably utilizes sodium carbonate peroxyhydrate to provide hydrogen peroxide to target and control cyanobacterial in their early stages of growth or regrowth at the bottom, or benthic surface and water, of a body of water such as a lake or pond. Many cyanobacteria live and proliferate in water bodies across the world. Their annual growth often begins at the bottom of a lake, pond, reservoir, or other surface water. The life cycle for many problematic cyanobacteria begins early when the colder season water begins to warm in the benthic region of the water column, reaching about 15° C./60° F., much earlier in the season than when they start causing problems when water temperatures become much warmer and these cyanobacteria “bloom” throughout the water column and surface of the water body. At this early stage of growth the process of the present invention target them by applying a hydrogen peroxide liberating material, preferably sodium carbonate peroxyhydrate (such a Green Clean PRO®, BioSafe Systems LLC, East Hartford, CT), preferably when the cyanobacteria are beginning to actively grow on the “hydrosoil” or surface of the sediment at the bottom of the waterbody Conventionally, sodium carbonate peroxyhydrate is typically utilized during the warmer spring and summer months when the water is warm and the algae and cyanobacteria are actively growing. Control of the algae is most easily achieved when algae are not yet well established, but also when water temperatures are warm. The warm water accelerates the reaction of the sodium carbonate peroxyhydrate with the body of water. The sodium carbonate peroxyhydrate is typically applied to the surface of the water where it reacts relatively quickly, dissolving and releasing hydrogen peroxide in the top several feet of the water (from the surface and down to 3-5 feet, generally). The warmer the water temperature, the faster the dissolution in water and reaction on the target organism.

However, in the process of the present invention, the process is preferably carried out when the cyanobacteria are easily targetable, early, before they proliferate and bloom. In the present process, the sodium carbonate peroxyhydrate is preferably applied when the water is colder before the a “bloom” becomes apparent. At the lower temperature, the sodium carbonate peroxyhydrate in the form of granules or “prill” dissolves and reacts much more slowly than later in the season when the water has warmed. Preferably, the granules are selected by average particle size to dissolve slowly. In some aspects of the invention, the granule composition may be selected to modify the dissolution rate, such as by adding excipients to the sodium carbonate peroxyhydrate and/or other modifiers of the granules physical properties. For example, the average density of the granules can be selected to modify the time required to sink to the bottom of the body of water, or the granules may be coated with porous coating, or a coating dissolving more slowly than the bulk of the granules.

Preferably, the granules sink to a target zone at the bottom of the water body. There the granules tend to more slowly dissolve and the sodium carbonate peroxyhydrate more slowly react. Typically, there will be less turbulence, and the granules will dissolve slowly, to allow hydrogen peroxide to reside in target zone longer and thus obtain an effective CET (concentration exposure time) on the cyanobacterial cells on top of the sediment.

The target area is the surface of the pond's bottom and/or the cyanobacteria on that surface and in the bottom layer water of the water body. The process of the present invention preferably targets the living cells of cyanobacteria in the water and on the sediment, and also the akinetes of these cyanobacteria—these are the resting, survival dormant “spore” cells that begin new growth after cold season.

Preferably, a large average granule size with a narrow particle size distribution is employed in the present process. Sodium carbonate peroxyhydrate granules selected to have a particle size between 700 and 900 microns are preferred.

Preferably, the granules are applied by scattering them over the surface of the body of water. Optionally, the granules can also be used to prepare a slurry, which can by pumped directly to the bottom of the body of water. This latter method may not deliver the ease or accuracy application compared to surface distribution.

Various modifications can be made in the details of the various embodiments of the methods of the present invention, all within the scope and spirit of the invention and defined by the appended claims.

1. A process for controlling cyanobacteria in a body of water, the process comprising:
a) selecting a body of water for treatment, the body of water having a benthic layer including cyanobacteria;
b) providing a granular source of hydrogen peroxide; the granular source having a density greater than the density of the water;
c) dispersing the granular source in the body of water,
d) permitting the granular source to dissolve to provide hydrogen peroxide to the benthic layer.

2. The process of claim 1, wherein the granular source is dispersed on the surface of the body of water.

3. The process of claim 1, wherein the granular source of hydrogen peroxide is sodium carbonate peroxyhydrate.

4. The process of claim 3 wherein the average particle side of the granular source of hydrogen peroxide of from about 700 microns to 900 microns.

5. The process of claim 1 wherein body of water has a bottom, and the granular source of hydrogen peroxide is provided adjacent the bottom of the body of water.

6. The process of claim 5 where the granular source of hydrogen peroxide releases hydrogen peroxide adjacent the bottom of the body of water.

7. The process of claim 1 wherein the body of water is thermally stratified.

8. The process of claim 1 wherein the quantity of hydrogen peroxide released is sufficient to control the cyanobacteria.
